(19) United States
(12) Patent Application Publication
(10) Pub. No.: US 2016/0019610 A1
(43) Pub. Date: Jan. 21, 2016

(54) SYSTEM FOR AGGREGATING, COMPARING AND ACQUIRING COLLECTIBLES, METHODS AND USES THEREOF

(71) Applicant: Collectors Universe, Inc., Santa Ana, CA (US)

(72) Inventors: Donald E. Willis, JR., Huntington Beach, CA (US); David Hall, Coto de Caza, CA (US); Miao Chen, Irvine, CA (US); John C. Nelson, Laguna Hills, CA (US)

(21) Appl. No.: 14/335,219

(22) Filed: Jul. 18, 2014

(51) Int. Cl. G06Q 30/06

(52) U.S. Cl. CPC G06Q 30/0603; G06Q 30/0641; G06Q 30/0625

(57) ABSTRACT

A system for acquiring and managing collectibles is disclosed and described herein that comprises: a first subject collectibles database, a global collectibles database, a collectibles catalog, a comparison module, a search module, and a reporting module. In some contemplated embodiments, the system further comprises a sales module or interface. Each of these databases, catalogs and modules are described in detail herein, along with how they are operatively connected and utilized. A separate online collectible marketplace, which may act as a companion or component to the system for acquiring and managing collectibles or may be independent from that system, comprises: a global collectibles database comprising information from at least two different sources, a collectibles catalog and a search module. Methods and applications are also disclosed.

### FIELD OF THE SUBJECT MATTER

The field of the subject matter is systems for aggregating, comparing and acquiring collectibles, methods and uses thereof, including comparing and valuing complete or incomplete sets of collectibles with respect to other individual collectibles or other sets of collectibles.

### BACKGROUND

Collectible items, such as coins, stamps, sports cards and cars, were sold and acquired through shops, private sales and trade shows until the widespread acceptance and use of the Internet. But even after some collectors and shops moved online, traditional methods of acquiring collectibles remained the primary way to view, purchase and/or trade collectible items. Therefore, information found online is usually incomplete, as to what items may actually be available for acquisition.

U.S. Pat. No. 6,366,899 issued to Kernz and entitled “Apparatus and Method for Accessing a Coin Image Compilation” discloses the early use of an online database for coin graders and sellers to upload and display their inventory. Specifically, Kernz disclosed: “A method for providing a database of images of graded objects comprising the steps of: a. grading an object based upon a predetermined grading scale and generating a grade indicator for the object; b. associating the grade indicator with the object in a tamperproof manner; c. assigning a unique identifying indicia to the object and associating the unique identifying indicia with the object in a tamperproof manner; d. generating a compilation of associated images of the object including a gross image, at least one magnified image and at least one image showing the object with the associated grade indicator, digitizing the images for viewing and assigning the unique identifying indicia to the compilation; e. storing the compilation associated with the unique identifying indicia in a database; and f. repeating said steps a. through e. for a plurality of objects to generate an associated compilation of images for each object and to store the compilations in the database whereby each of the compilations can be retrieved from the database by selecting the assigned associated unique identifying indicia and the images in the retrieved compilation can be viewed.” The stated goal of this subject matter was to make it easier for sellers to list their inventory and for potential purchasers to be able to access a particular inventory online. U.S. Pat. No. 6,643,666, also issued to Kernz, continued this line of subject matter by creating a marketplace computer for electronically trading graded objects.

U.S. Pat. No. 6,640,323 issued to Kernz is a continuation of the above-referenced patents and discloses apparatus and methods for selectively displaying a coin image compilation, along with U.S. Patent Publication 2004/0039663, which is now abandoned. The latter publication discloses an “improved market exchange environment” or a “virtual active marketplace” where buyers and sellers can use interconnected computers to trade objects to be collected. These four Kernz patent references teach the online presentation of collectibles, along with the buying and selling of those collectibles, but fails to improve the process past that point.

Unfortunately, collectors can (and usually do) spend hours searching the Internet for sets or for items to complete or enhance their collectible sets, because there are no acceptable search algorithms and aggregators to pull that information together for the collector in one area, such as what you might find with Pricegrabber.com or Amazon.com. The Kernz patent references don't solve these problems either, because they are just disclosing the automation and presentation of inventories without tying them all together in one place. Collectors are not helped or supported in the same way a consumer is who is searching for a new flat screen TV or a new book.

In addition, the problem is made worse by the fact that many smaller dealers or shops do not keep a current inventory online, where the inventory not only lists the item, but has a picture, a condition, a value and a certificate number, if one is available for the collectible. Therefore, collectors are left to wonder if the item is still available or whether it can be acquired somewhere else for a better price or of a better quality.

Finally, collectors may find it difficult to determine which new collectibles or upgraded collectibles will enhance the value of their collection more over the addition or upgrading of other pieces. Conventional methods of determining set value may take hours of time, if it can be done at all, and may not be accurate or reproducible.

To this end, it would be desirable to develop, produce and utilize a system that: a) allows sellers to catalog available collectibles in dealer inventories, auction inventories or a combination thereof on the Internet, b) matches online inventories against various set registries and catalogs on the internet, c) creates an index for collectibles buyers, so that they can browse the inventory of a large number of dealers at one time and in one location, d) allows collectors to compare their individual collectibles or sets to other publicly-listed collections, e) allows collectors to set up a “wish list” for items that they want to acquire or add to their collections with the wish list being an alert-based system, and f) calculates the value of the user's set or sets and provides information as to the available inventory on the market that can improve the collector's set or sets and by how much.

### SUMMARY OF THE SUBJECT MATTER

Specifically, a system for acquiring and managing collectibles is disclosed and described herein that comprises: a first subject collectibles database, a global collectibles database, a collectibles catalog, a comparison module, a search module, and a reporting module. In some contemplated embodiments, the system further comprises a sales module or interface. Each of these databases, catalogs and modules are described in detail herein, along with how they are operatively connected and utilized.

A method for acquiring and managing collectibles, includes: providing a first subject collectibles database, providing a global collectibles database, providing a collectibles catalog, providing a comparison module, providing a search module, providing a reporting module, wherein the reporting module is operatively connected to the search module, accessing the global collectibles database, using the comparison module to compare the first subject collectibles database with the global collectibles database, the collectibles catalog or both, identifying desirable collectible upgrades, desirable collectible additions or a combination thereof, using the search module to selectively search the internet for the identified upgrades, additions or a combination thereof, and presenting the information obtained by the search module on a display by using the reporting module.

A separate online collectible marketplace, which may act as a companion or component to the system for acquiring and managing collectibles or may be independent from that system, comprises: a global collectibles database comprising information from at least two different sources, a collectibles catalog and a search module.

### BRIEF DESCRIPTION OF THE FIGURES

FIG. 1 shows a contemplated system 100 for acquiring and managing collectibles is disclosed and described herein that comprises: a first subject collectibles database 110, a global collectibles database 120, a collectibles catalog 130, a comparison module 140, a search module 150, and a reporting module 160. In some contemplated embodiments, the system 100 further comprises a sales module or interface 170. In other embodiments, the system further comprises an alert module 180.

A method 200 for acquiring and managing collectibles is shown in FIG. 2 and includes: providing a first subject collectibles database 210, providing a global collectibles database 220, providing a collectibles catalog 230, providing a comparison module 240, providing a search module 250, providing a reporting module 260, wherein the reporting module is operatively connected to the search module, accessing the global collectibles database, using 270 the comparison module to compare the first subject collectibles database with the global collectibles database, the collectibles catalog or both, identifying 280 desirable collectible upgrades, desirable collectible additions or a combination thereof, using 290 the search module to selectively search the internet for the identified upgrades, additions or a combination thereof, and presenting 295 the information obtained by the search module on a display by using the reporting module.

FIG. 3A shows information 310 and 320 for a user's First Subject Collectibles Database at the top of the page, including the rank, the degree of completion, etc. As the user toggles down the page and as shown in FIG. 3B, the user is provided links 330 to “Add Best Available Items”, which will provide information on how to globally update the user's set with any available items in the Global Collectibles Database, Delete or Move Coins within the set, Sell Coins out of the First Subject Collectibles Database or add Missing Coins to the Watch List (“Coins I'm Watching”). The user is then presented with all of the available coins 340 from the Global Collectibles Database 350 that the user may want to view to add to and/or improve his or her set.

FIG. 4 shows a simple Global Collectibles Database 400 where a number of types of coins 410 are shown for the United States 405 (as opposed to China 407), along with a number link 420 that shows how many of that particular type of coin are currently globally available for purchase or acquisition. FIG. 4 shows the Gold Coins grouping 430, if the user clicks on the number link 440 next to the $4 Stella, the four available coins will be shown under the link on the page or in a pop-up image.

FIG. 5 shows a contemplated comparison module interface 500, wherein the user (not shown) is considering upgrading his or her set 510 with an Everyman Barber Half Dollar 520. The comparison module shows that four 1901-0 coins 530 were found and three 1910 coins 540 were found. The user is able to view each of these seven coins on their own and then “View My Set” 550 to see the current value of the user's set, what the set would be valued at if each one of the seven coins were added to the user's set or used to replace a lesser valued coin in the user's set, and how the user's set compares to other user's sets. Coins that are in the Collectibles Catalog but not found in the Global Collectibles Database can be hidden by selecting the “Hide Coins Without Matches” link 560, because collectors may not be interested in seeing coins that are not available for acquisition. The “What If” 570 link allows the user to view his or her set 510, if various coins are added to the set or used to replace lower value coins or collectibles in the set.

FIG. 6A and 6B shows an interface 610 where the user (not shown) can easily compare his or her Current set 620, with various other Ideal Sets, including “What If” 630, “Next Rank” 640, “#1 Set” 650 and “Finest Possible” 660. The list 670 below in FIG. 6B allows the user to easily compare coins 680 on one webpage within the set, add coins to the set and reset back to the original set 690 on one page without viewing multiple websites and individual pages.

In FIG. 7, the Braided Hair Cent page 710 is shown. In the top right corner of the page, the user (not shown) can use the window 720 to narrow down the seller, the grade and the price. And while this window can be used as a sort feature, the user can also set alerts and notifications from this window. For example, the user can set a grade and/or a price and click on “Alert Me” 730, and when Braided Hair Coins of that grade and/or price come into the Global Collectibles Database, the user is notified. This Alert does not appear under the “Coins I'm Watching”, but instead appears under the Alert Module feature and related icon. It should be noted on this page as well that the user has clicked on the 1855 1C Upright, 740, where one was found, and has pulled up the digital image 750 and detailed information 760 without leaving the page 710.

The Dashboard 800, as shown in FIG. 8, may show a number of contemplated features, including “Coins I'm Watching” 810, which is a simple list of the coins that the user is keeping an eye on for some reason.

As shown in FIG. 9, the user is accessing the Global Collectibles Database page 900 and wants to quickly view the “Coins I'm Watching” 910. All the user has to do is click on the icon 920 at the top of the page and a pop-up window 930 opens that shows these coins 933, along with a refresh 936 option and a delete option 939. Each of these items in the pop-up window are also accessible by clicking on the link associated with the item. In addition, the user can set up a number of icons 940 to “follow” the user around from page to page, including notifications or alerts 944.

### DETAILED DESCRIPTION

A system has been developed and is described herein that: a) allows sellers to catalog available collectibles in dealer inventories, auction inventories or a combination thereof on the internet, b) matches online inventories against various set registries and catalogs on the internet, c) creates an index for collectibles buyers, so that they can browse the inventory of a large number of dealers at one time and in one location, d) allows collectors to compare their individual collectibles or sets to other publicly-listed collections, e) allows collectors to set up a “wish list” for items that they want to acquire or add to their collections or collections they want to acquire with the wish list being an alert-based system, and f) calculates the value of the user's set or sets and provides information as to the available inventory on the market that can improve the collector's set or sets and by how much. Contemplated systems are a true advancement over current, flawed and incomplete methods for selling or acquiring collectibles and completing collections.

Introduction

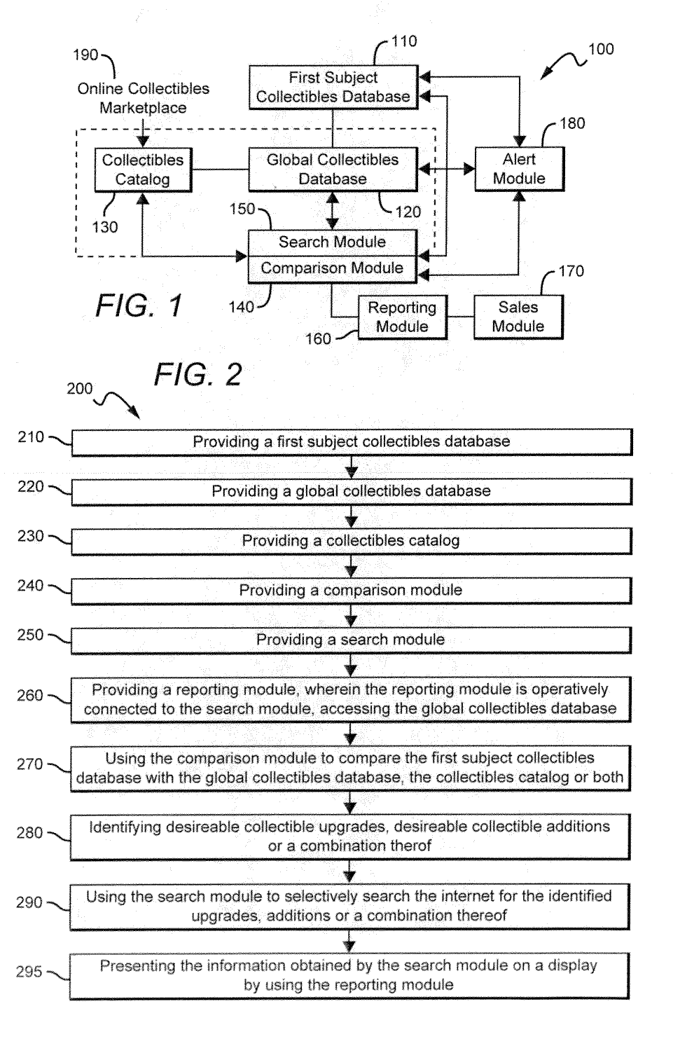

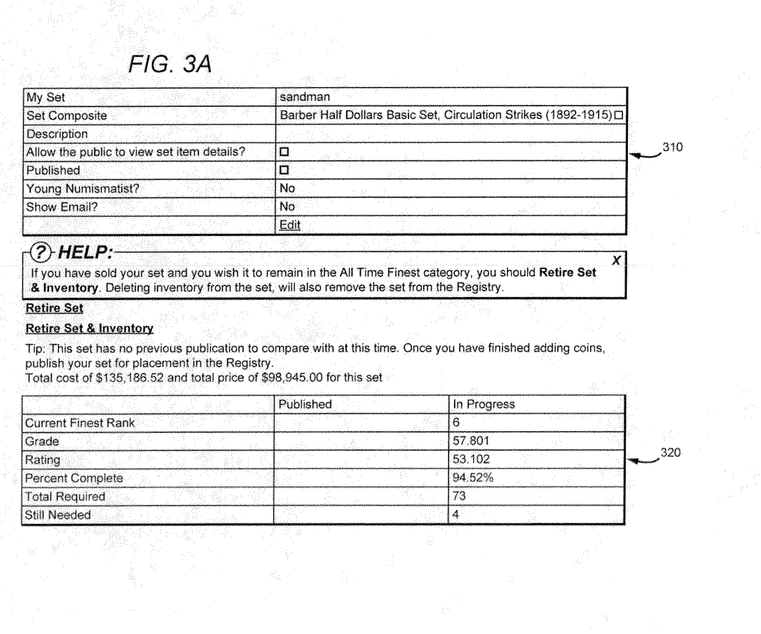

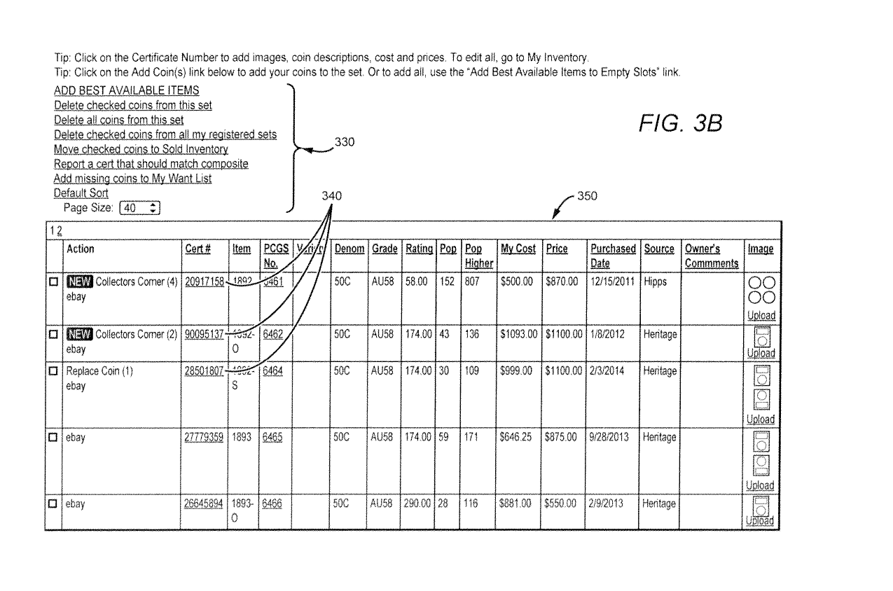

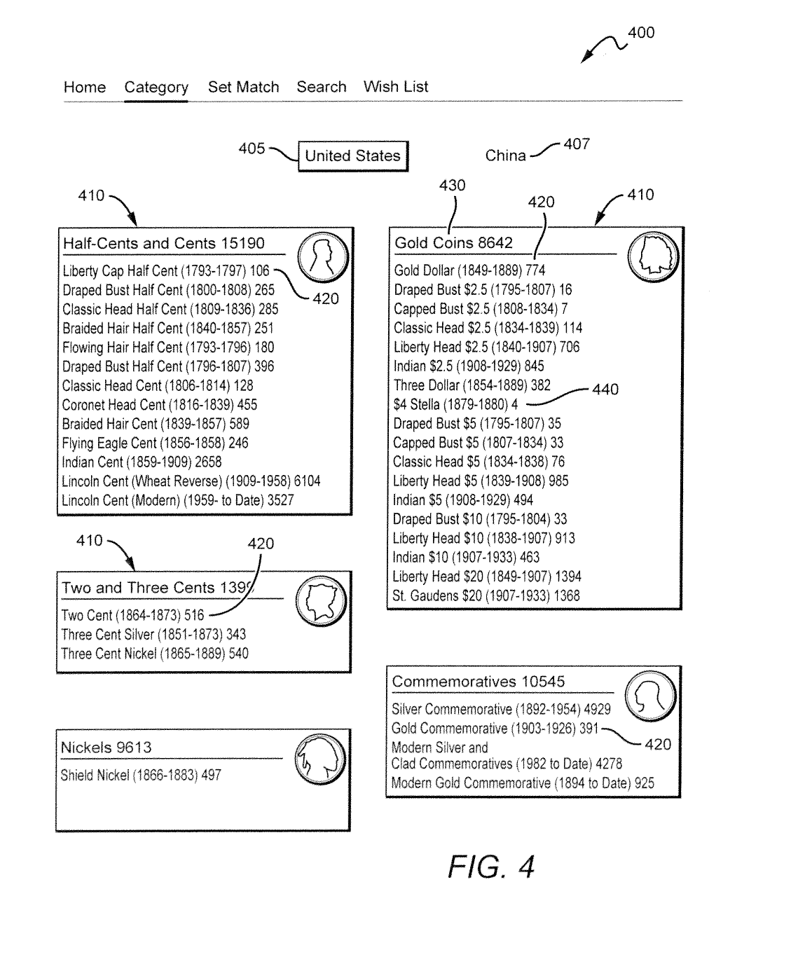

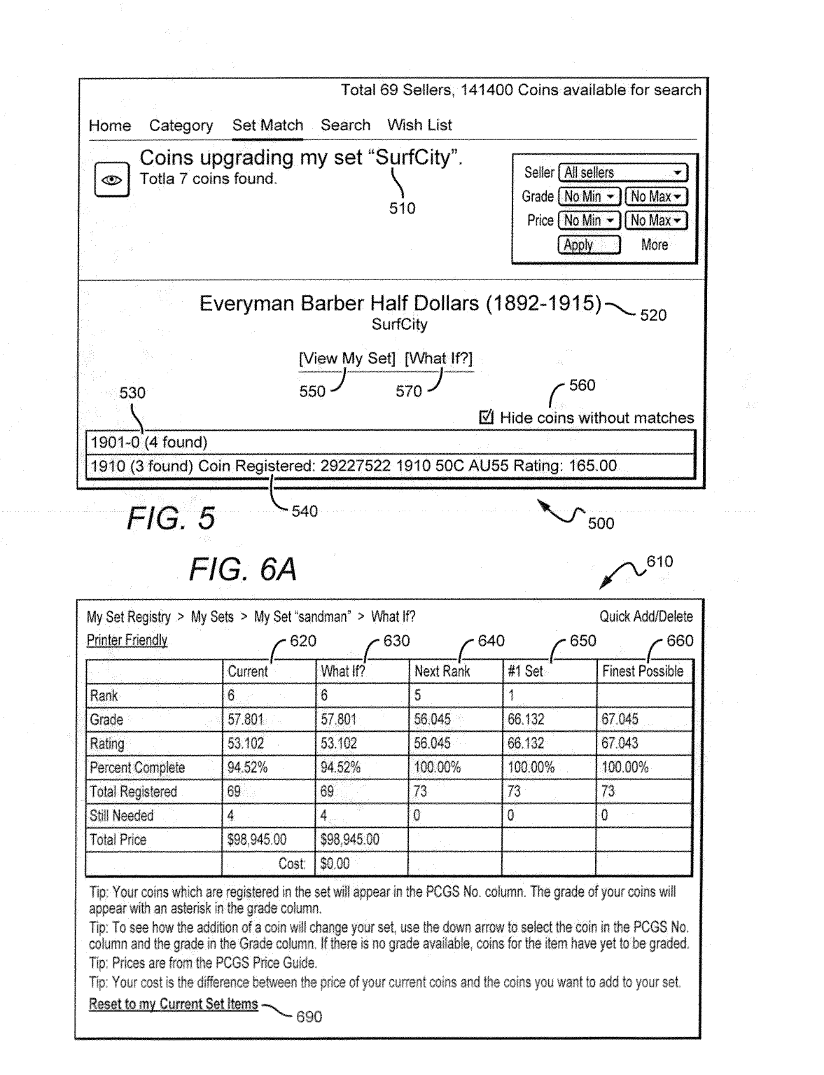

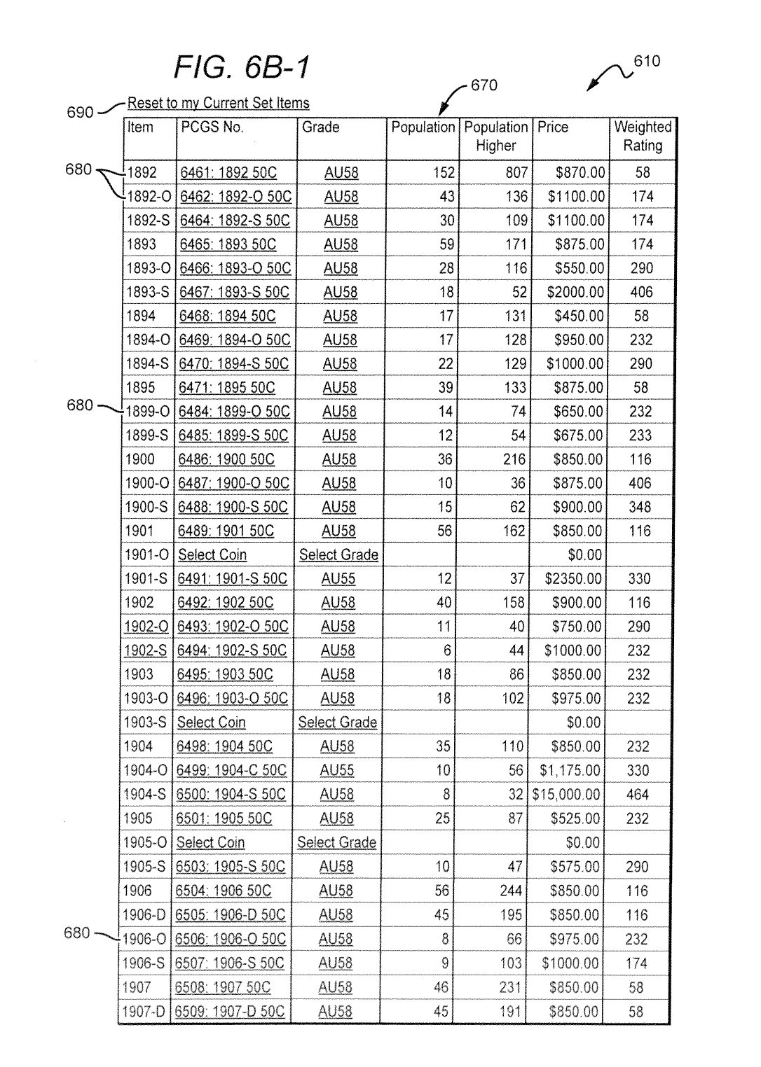

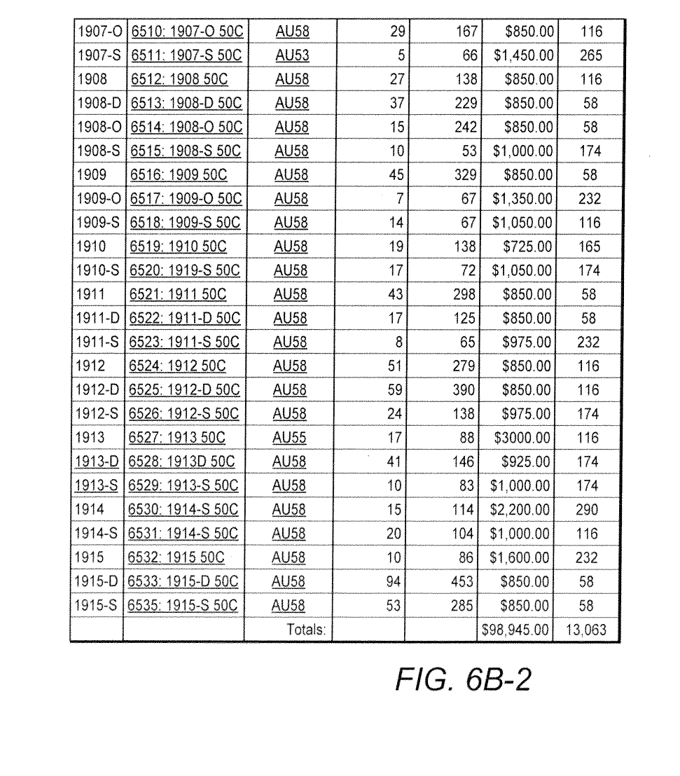

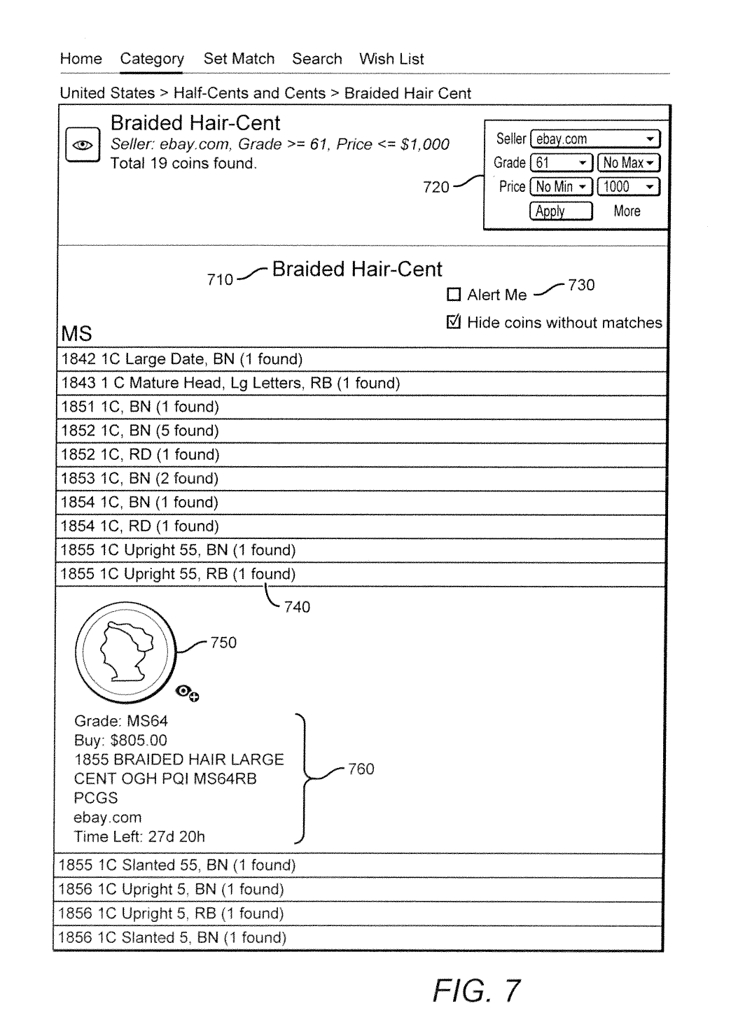

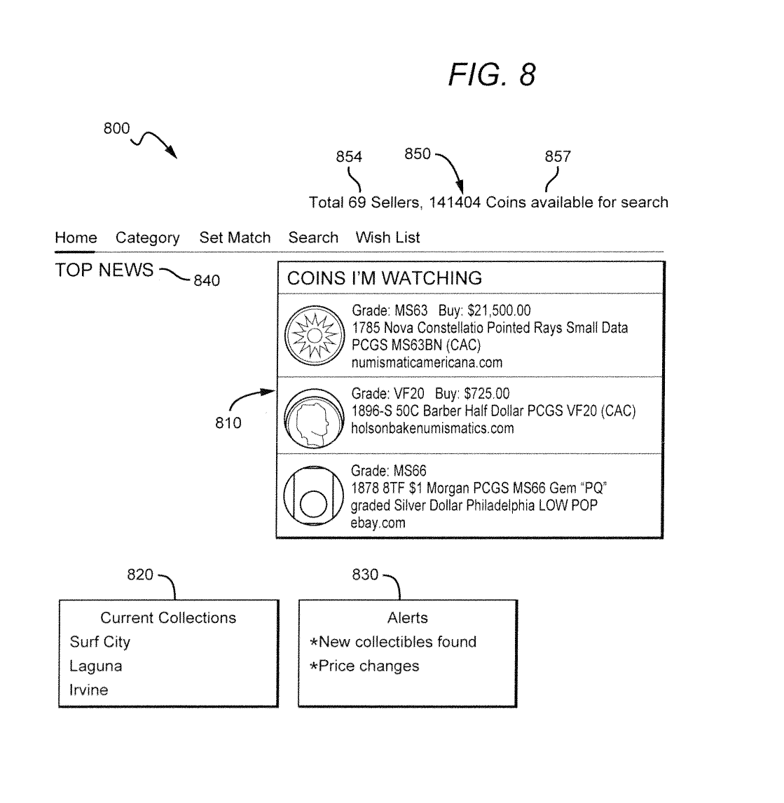

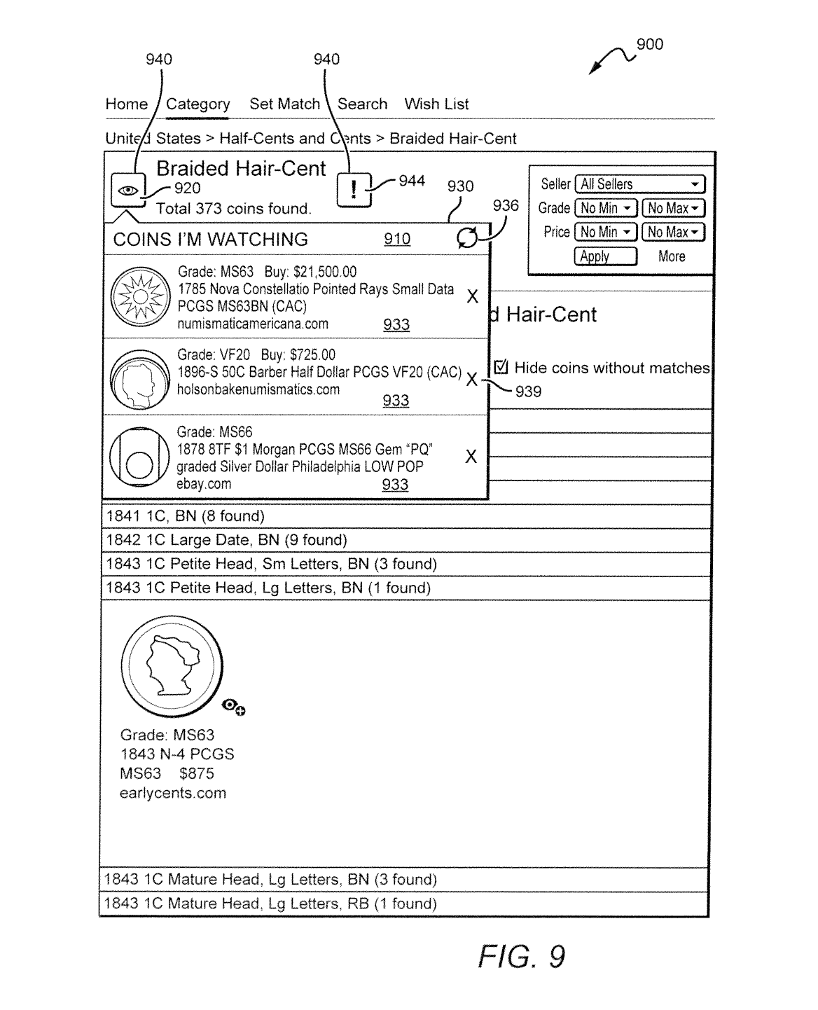

Specifically and as shown in FIG. 1, a system 100 for acquiring and managing collectibles is disclosed and described herein that comprises: a first subject collectibles database 110, a global collectibles database 120, a collectibles catalog 130, a comparison module 140, a search module 150, and a reporting module 160. In some contemplated embodiments, the system 100 further comprises a sales module or interface 170. In other embodiments, the system further comprises an alert module 180. Each of these databases, catalogs and modules are described in detail herein, along with how they are operatively connected and utilized.

Systems and methods disclosed herein advance the collector's ability not only to review online databases and collectible grades, but compare collectibles from multiple sites and dealers, compare with collectibles in the collector's current sets, suggest upgrades to the collector based on what is available on the market, and set up an alert system that will alert a collector when a collectible becomes available on the market.

A method 200 for acquiring and managing collectibles is shown in FIG. 2 and includes: providing a first subject collectibles database 210, providing a global collectibles database 220, providing a collectibles catalog 230, providing a comparison module 240, providing a search module 250, providing a reporting module 260, wherein the reporting module is operatively connected to the search module, accessing the global collectibles database, using 270 the comparison module to compare the first subject collectibles database with the global collectibles database, the collectibles catalog or both, identifying 280 desirable collectible upgrades, desirable collectible additions or a combination thereof, using 290 the search module to selectively search the internet for the identified upgrades, additions or a combination thereof, and presenting 295 the information obtained by the search module on a display by using the reporting module.

A separate online collectible marketplace, which may act as a companion or component to the system for acquiring and managing collectibles or may be independent from that system, comprises: a global collectibles database comprising information from at least two different sources, a collectibles catalog and a search module. This contemplated marketplace is distinguished over the Kernz patent references in that the contemplated marketplace “crawls” all available online sources and pulls back relevant information in a format where collectibles from multiple vendors can be compared in an easy and relatable format.

Software applications that can be saved on a smartphone, tablet, computer, the cloud, a global network, or laptop and that can access the systems and methods disclosed herein are also contemplated.

First Subject Collectibles Database

A contemplated first subject collectibles database is the one or more individual collections of collectibles owned by an individual, trust, entity or company. This database is the electronic collection and representation of identifying information related to a physical collection of collectibles.

For example, a collector may have a set of collectible coins at home in a vault. The identifying information, including type, value, condition and other suitable information, along with a photo, is uploaded to or entered into the first subject collectibles database, which represents what the collector currently has in his or her collection. This information can also be used to compare with other collectors' sets through a set registry, such as the PCGS Set Registry, wherein collectors can register their coin sets, compare their sets with other collectors and compete with other collectors for who has the better coin set. A second, third or subsequent subject collectibles database is contemplated and will be described below in relation to the system.

FIG. 3A shows information 310 and 320 for a user's First Subject Collectibles Database at the top of the page, including the rank, the degree of completion, etc. As the user toggles down the page and as shown in FIG. 3B, the user is provided links 330 to “Add Best Available Items”, which will provide information on how to globally update the user's set with any available items in the Global Collectibles Database, Delete or Move Coins within the set, Sell Coins out of the First Subject Collectibles Database or add Missing Coins to the Watch List (“Coins I'm Watching”). The user is then presented with all of the available coins 340 from the Global Collectibles Database 350 that the user may want to view to add to and/or improve his or her set.

Global Collectibles Database

A global collectibles database is the database of available collectibles for purchase, trade or acquisition. Available collectibles also includes those that are part of online auctions. This database is the electronic collection and representation of identifying information, including digital photos where available, and cost of a group of collectibles. FIG. 4 shows a simple Global Collectibles Database 400 where a number of types of coins 410 are shown for the United States 405 (as opposed to China 407), along with a number link 420 that shows how many of that particular type of coin are currently globally available for purchase or acquisition. FIG. 4 shows the Gold Coins grouping 430, if the user clicks on the number link 440 next to the $4 Stella, the four available coins will be shown under the link on the page or in a pop-up image. Note that the four that are found will be shown in more detail, with a digital image (if one is available), the grade, the price, the vendor information, the auction information (if it is an auction), and if it is an auction, the time left. It is also contemplated that the user can click on one of the four items (or multiples) and directly set up alerts using the Alert Module (that is described later herein) or set the item up as a “Coin I'm Watching” on the user's Dashboard.

This contemplated database is updated on a regular basis—either at particular and specific time intervals or randomly over a given period of time. This contemplated database is also updated to show when an auction may end or when an item has been sold and is no longer available. In addition, especially when one of the collectibles is being presented as an auction item, the cost or most recent bid may be updated on a shorter timeframe as the end of the auction approaches. So, when the item is first put up for bid, it may be updated every 6 or 8 hours, but as the auction gets closer to the end, the cost or most recent bid is updated every hour, every half hour, every 5 or 10 minutes, or every minute. It should be understood that the term “auction” or “auctions”, as used herein, refers to online or live auctions. For both live and online auctions, it may be that the auction house has set up an online component or a pre-bidding component that is found online. This information will be found by contemplated systems and contained within the Global Collectibles Database, as understood.

Collectibles Catalog

Contemplated collectibles catalogs are those catalogs that are prepared, and in many instances proprietary, to a company who specializes in collectibles. One example of a contemplated catalog is PCGS Numbering System, which contains information about United States coins and can be found at http://www.pcgs.com/pcgsnolookup/. Contemplated catalogs are operatively connected as part of the comparison module to both the first subject collectibles database and the global collectibles database. A collector can compare his or her set (first subject collectible database) to the catalog or can compare potential additions (global collectibles database) to his or her set to the catalog.

Comparison Module

One of the unique aspects of contemplated embodiments is the comparison module. Not only does this module function, as already stated, to compare the first subject collectibles database and/or the global collectibles database to each other and/or one or more collectibles catalogs, but it can also function to create a second subject collectible database, a third subject collectible database or a subsequent subject collectible database. These databases are what the first subject collectible database would look like if a particular collectible were added or if a collectible in the database were upgraded and replaced. A collector is able to envision what his or her collection would be valued at or how it would rank in a list of other collectors sets easily and on the fly as collectibles become available to the market. In some embodiments, the collector may decide to just see what available collectibles would improve the set regardless of what individual item is being added. The comparison module will show the collector which collectibles will improve the collectors set and by how much, as compared with other additions.

A contemplated comparison module can also be set or directed by the collector based on the collector's resources. For example, the collector may indicate to the system that the collector: a) wants to improve his or her coin set A, and b) only has $10000 to spend. So in one embodiment, the collector will select coin set A from the Dashboard or the Collector's listing, click on “Improve My Set” and then select from the following options: “Find the Best Coin”, “Complete My Set”, “Improve My Set”, or “Use This Budget”. If the latter is selected, a prompt will ask the collector what the budget is—which in this case is $10000. The comparison module will work in conjunction with the search module, the report module and possibly the alert module to provide this information to the collector with respect to the current information in the global collectibles database and with respect to future information—as it becomes available—in the global collectibles database.

FIG. 5 shows a contemplated comparison module interface 500, wherein the user (not shown) is considering upgrading his or her set 510 with an Everyman Barber Half Dollar 520. The comparison module shows that four 1901-0 coins 530 were found and three 1910 coins 540 were found. The user is able to view each of these seven coins on their own and then “View My Set” 550 to see the current value of the user's set, what the set would be valued at if each one of the seven coins were added to the user's set or used to replace a lesser valued coin in the user's set, and how the user's set compares to other user's sets. Coins that are in the Collectibles Catalog but not found in the Global Collectibles Database can be hidden by selecting the “Hide Coins Without Matches” link 560, because collectors may not be interested in seeing coins that are not available for acquisition. The “What If” 570 link allows the user to view his or her set 510, if various coins are added to the set or used to replace lower value coins or collectibles in the set.

FIG. 6A and 6B shows an interface 610 where the user (not shown) can easily compare his or her Current set 620, with various other Ideal Sets, including “What If” 630, “Next Rank” 640, “#1 Set” 650 and “Finest Possible” 660. The list 670 below in FIG. 6B allows the user to easily compare coins 680 on one webpage within the set, add coins to the set and reset back to the original set 690 on one page without viewing multiple websites and individual pages.

Search and Report Modules

The module that elevates most of these databases, modules and embodiments to a level that is currently unavailable is the search module, alone or in combination with the reporting module. A contemplated search module combs the internet for available collectibles, whether they are for sale, for auction or offered in trade. The search module is then operatively connected to the reporting module, which takes all of the information gathered by the search module, standardizes it for display and reports it to the consumer in one, easy to read, easy to compare report. The results of the Search Module and Reporting Modules can be found throughout the Figures, including FIGS. 3, 5, 6 and 7. To date, collectors were left with a standard google.com, yahoo.com or Bing search that pulls back everything related to a collectible. Contemplated search modules can be configurable for a dealer site, vendor site, auction site or trade show site. Contemplated modules are designed to read the available inventory or available auction items. The reporting module may be designed so that it increases the frequency of updates to the collector as an auction close for a particular collectible approaches.

For example, if a collector searched “Albert Pujols Topps rookie card”, a conventional search would pull back places that currently sell the card, did sell the card, old auctions, articles about Albert Pujols, Topps, etc. Contemplated search modules are specifically designed to only collect those sites where an Albert Pujols Topps rookie card is currently being sold, offered or auctioned and a contemplated reporting module that collects that information and presents it to the collector in a concise, standardized and easy to interpret way. The collector can then compare the information quickly without having to spend hours going from site to site to determine if the collectible is available and if the information is accurate.

Alert Module (“The Intelligent Agent”)

One additional and contemplated module is an alert module, which is another unique facet of contemplated embodiments. The alert module can also be referred to as the “intelligent agent”, because it's “job” is to work as an agent for the user to collect information as it comes into the global collectibles database.

The alert module works in conjunction with the comparison module, the search module and the reporting module to provide collectors with a way to “watch for” certain collectibles entering the available market, price changes on targeted collectibles or better quality collectibles coming on to the available market. Once the collector identifies items to watch for or parameters to search for, the alert module will send a text, E-mail or another suitable alert to the collector once an item has been located or conditions have changed for identified collectibles.

In some instances where a particular item is up for bid at an auction, the user may set up an alert to notify him or her when the item is in the last 5 minutes (or a predetermined time window) of the auction, if his or her bid has been exceeded or if the price has reached a certain amount.

One aspect of the Alert Module is shown in FIG. 7 and allows the user to set parameters and standards for a particular collectible. In FIG. 7, the Braided Hair Cent page 710 is shown. In the top right corner of the page, the user (not shown) can use the window 720 to narrow down the seller, the grade and the price. And while this window can be used as a sort feature, the user can also set alerts and notifications from this window. For example, the user can set a grade and/or a price and click on “Alert Me” 730, and when Braided Hair Coins of that grade and/or price come into the Global Collectibles Database, the user is notified. This Alert does not appear under the “Coins I'm Watching”, but instead appears under the Alert Module feature and related icon. It should be noted on this page as well that the user has clicked on the 1855 1C Upright, 740, where one was found, and has pulled up the digital image 750 and detailed information 760 without leaving the page 710.

The user can also set up the alert module to provide an alert any time that any collectible comes on to the market that will make the collector's set better or more valuable. This feature is critical for collectors, in that they can set this feature and walk away, thus leaving the “intelligent agent” to recognize new items in the global collectibles database, compare those items with the collector's set or sets, determine if the new collectible will make the collector's set better—and if so, notify the collector with an alert as to the item, the vendor/dealer, the price and the estimated value increase to the collector's set or sets.

Sales Module

Once the collector has all of the information in front of him or her, as to available collectibles, the condition and cost of those collectibles and how those collectibles will change the value of the first subject collectible database, the collector can use a contemplated sales module to acquire the collectible, if desired. The sales module will also allow the collector to list individual items in his or her collection. For example, if the collector upgrades his collection by adding a better quality coin, the already-owned lower quality coin may be then listed for sale by the collector. The Sales Module will also allow the user to buy the coin directly from the detailed listing on the page, if desired.

The Online and Mobile Dashboard

It is contemplated that all of the contemplated databases and modules can be easily and simply represented on the user's Online and Mobile Dashboard. The Dashboard 800, as shown in FIG. 8, may show a number of contemplated features, including “Coins I'm Watching” 810, which is a simple list of the coins that the user is keeping an eye on for some reason. The user may want to see if their prices drop or change, may want to consider buying them at a later date or may want to save the information to call the dealer. A contemplated dashboard may also provide links to the user's current collections 820, so that they are easily accessible from one place. A contemplated dashboard may also provide alert notices 830, an interface to the sales module, a running ticker of online news 840 and alerts related to the user's collections and preferences, and a number of other pieces of information. It is also contemplated that the online and mobile dashboard can be set up according to each user's preferences and what he or she wants to see when it is accessed. The “Coins I'm Watching” feature may be at the top of the page or the bottom of the page. In other words, this Dashboard is configurable from a number of available options. Another piece of information contemplated systems provide is a summary of the Global Collectibles Database 850, that shows the number of sellers 854 and the coins available for search 857.

It is also contemplated that various aspects of the Online and Mobile Dashboard can be accessed immediately as the user is using the various features of the overage marketplace. As shown in FIG. 9, the user is accessing the Global Collectibles Database page 900 and wants to quickly view the “Coins I'm Watching” 910. All the user has to do is click on the icon 920 at the top of the page and a pop-up window 930 opens that shows these coins 933, along with a refresh 936 option and a delete option 939. Each of these items in the pop-up window are also accessible by clicking on the link associated with the item. In addition, the user can set up a number of icons 940 to “follow” the user around from page to page, including notifications or alerts 944.

As mentioned, a separate online collectible marketplace, which may act as a companion or component to the system for acquiring and managing collectibles or may be independent from that system, is contemplated and comprises: a global collectibles database comprising information from at least two different sources, a collectibles catalog and a search module. This contemplated embodiment is designed for a new collector or for someone who is just trying to search for a specific collectible irrespective of his or her personal collection. The contemplated global database comprises information from at least two different sources, which may be two different vendors, a vendor and an auction site, a trade show and another vendor or a combination of these. It should be understood that while the global collectibles database comprises information from at least two different sources, that doesn't mean that every collectible has at least two different listings. In some embodiments and with some collectibles, there may only be one available from only one of the sources. If that is the case, that is the information presented to the collector.

The Dashboard, along with other pages throughout contemplated embodiments, can be designed to highlight preferred sellers, high volume dealers, and dealers or coins where there is a high value of confidence in the quality of the coins or the professionalism of the dealer/vendor.

The Dashboard may also be set up and communicated in app form on a smartphone, tablet or laptop. In these embodiments, the user can set up preferences and layout as well, and that layout may be different than the one found on the user's internet profile or layout.

Online Collectible Marketplace

A separate online collectible marketplace 190, which is shown enclosed by the dashed line in FIG. 1 and which may act as a companion or component to the system for acquiring and managing collectibles or may be independent from that system, comprises: a global collectibles database comprising information from at least two different sources, a collectibles catalog and a search module. Additional modules, such as the report and alert modules, are contemplated and can be utilized with the online collectible marketplace.

It should be understood that contemplated embodiments comprise a global collectibles database, as disclosed herein. However, the information provided to the global collectibles database comes from at least two different sources, wherein a source may be a vendor, dealer, auction house, collector or another source. The phrase “at least two different sources” may mean that the database comprises information from two different vendors, a vendor and a dealer, a collector and an auction house or two different collectors, for example.

A contemplated online collectible marketplace is designed to not only search a collectibles catalog, which is what the Kernz patent references disclose, but it searches collectibles catalogs, a global collectibles database (what is actually available) and reports this information to the user/collector.

Contemplated Displays and Systems

As described herein, contemplated embodiments can be stored on, executed from or accessed from a central server, network server, a central Cloud or another multi-user accessible and/or two-way system. In some embodiments, a contemplated handheld device, portable device or combination thereof may comprise a software “app” that is designed to access the Global Collectibles Database, the First Subject Collectibles Database, the Dashboard and any other piece of the contemplated system in order to present the user with a completely mobile, completely accessible system and Dashboard.

As part of these systems, a display device may be included that comprises a digital display, an interactive display with keyboard (actual, digital or voice recognition-enabled), a combination digital and paper artwork display or a combination thereof. Contemplated collectibles systems are designed to and have components that allow them to communicate with the handheld device, portable device or combination thereof.

Contemplated systems may also comprise a user-utilized handheld device, portable device or combination thereof. Contemplated devices may include a smart phone, hand held device, laptop computer or another suitable device with a network connection, data transfer connection, network data connection, cellular data network and/or connection, Wi-Fi connection, or another suitable device/link combination or connection that allows the user to communicate with contemplated collectibles systems, as disclosed herein.

Contemplated systems embodiments and related applications or apps are saved on, executed on, stored on or located on a portable media storage device, a hand held device, a tablet computer, a laptop computer, a desk top computer, a network server, an internet server, the cloud or a combination thereof.

Thus, specific embodiments and systems for aggregating, comparing and acquiring collectibles, methods and uses thereof, including comparing and valuing complete or incomplete sets of collectibles with respect to other individual collectibles or other sets of collectibles have been disclosed. It should be apparent, however, to those skilled in the art that many more modifications besides those already described are possible without departing from the inventive concepts herein. The inventive subject matter, therefore, is not to be restricted except in the spirit of the disclosure herein. Moreover, in interpreting the specification and claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced.

1. A system for acquiring and managing collectibles, comprising:
a first subject collectibles database configured to store user collectible information of an individual user corresponding to a physical collection of the individual user;
a global collectibles database configured to store available collectible information of collectibles available for purchase;
a collectibles catalog providing collectible information about a type of collectible;
a comparison module, wherein the comparison module is operatively connected to the first subject collectibles database, the global collectibles database and the collectibles catalog;
a search module configured to retrieve information relating to the available collectible information of collectibles available for purchase from two or more unrelated sources and populate the global collectibles database, wherein the search module is operatively connected to the comparison module and the global collectibles database; and
a reporting module to display the user collectible information, the available collectible information, wherein the reporting module is operatively connected to the search module.

2. The system for acquiring and managing collectibles of claim 1, further comprising a sales module or sales interface.

3. The system for acquiring and managing collectibles of claim 1, wherein the comparison module provides a second subject collectibles database, a third subject collectibles database or at least one additional subject collectibles database, wherein each database comprises a projection or estimated value, rank or combination thereof.

4. (canceled)

5. The system for acquiring and managing collectibles of claim 1, wherein the search module operatively accesses the internet.

6. The system for acquiring and managing collectibles of claim 1, wherein the search module acquires price information, sales information, condition information or a combination thereof for at least one collectible item and the reporting module displays the price information, the sales information, the condition information or a combination thereof on a display.

7-8. (canceled)

9. The system of claim 1, further comprising an alert module.

10-13. (canceled)

14. The system of claim 13, wherein the alert module is operatively connected to a data transmission system that can transmit text messages, electronic mail, alert instances or a combination thereof.

15. An interactive collectible dashboard, comprising:
the system for acquiring and managing collectibles of claim 1;
a graphical interface that is operatively and communicatively connected to the system for acquiring and managing collectibles, wherein the graphical interface shows information from the comparison module, the search module, the reporting module or a combination thereof.

16. The interactive collectible dashboard of claim 15, wherein the graphical interface also shows information from the alert module, the sales module or a combination thereof.

17. A method for acquiring and managing collectibles, comprising:
storing user collectible information of an individual user corresponding to a physical collection of the individual user in a first subject collectibles database;
providing available collectible information of collectibles available for purchase in a global collectibles database;
providing a collectibles catalog having collectible information about a type of collectible;
retrieving information relating to the available collectible information of collectibles available for purchase from two or more unrelated sources with a comparison module;
providing a search module;
providing a reporting module, wherein the reporting module is operatively connected to the search module;
accessing the global collectibles database;
using the comparison module to compare the first subject collectibles database with the global collectibles database, the collectibles catalog, or both;
identifying desirable collectible upgrades, desirable collectible additions or a combination thereof;
using the search module to selectively search an internet for the identified upgrades, additions or a combination thereof; and
presenting the information obtained by the search module on a display by using the reporting module.

18. An application that is saved on and executed from a smartphone, a laptop, a computer, a cloud or a tablet, wherein the application operatively executes the method of claim 17.

19. An online collectible marketplace comprising: a global collectibles database comprising information about collectables presently available for acquisition from at least two different sources, a collectibles catalog havin collectible information about a type of collectible and a search module configured to retrieve the information from the two different sources.

20. The system for acquiring and managing collectibles of claim 1, wherein the reporting module takes all of the information from the search module and standardizes it for the global collectibles database.

21. The system for acquiring and managing collectibles of claim 1, wherein the reporting module displays only a presently available set of results of available collectibles for sale at a time when a search is run by the search module, where the presently available set of results are displayed by the reporting module in a standardized format.

22. The system for acquiring and managing collectibles of claim 1, wherein the comparison module permits the individual user to refine results presented by the reporting module.

23. The system for acquiring and managing collectibles of claim 1, wherein the comparison module permits the individual user to limit results displayed by the reporting module to those that improve a quality of the physical collection as determined by the user collectible information stored in the first subject collectibles database.

24. The system for acquiring and managing collectibles of claim 1, wherein the comparison module permits the individual user to limit results displayed by the reporting module to those that are within a given budget of the individual user.

25. The system for acquiring and managing collectibles of claim 1, wherein the search module is configured to update the global collectibles database at predefined intervals.

26. The system for acquiring and managing collectibles of claim 1, wherein the search module is configured to update the global collectibles database at different predefined intervals depending on a source of the available collectible information.

27. The system for acquiring and managing collectibles of claim 1, wherein the user collectible information is the available collectible information.
